(19) United States
(12) Patent Application Publication
(10) Pub. No.: US 2009/0055851 A1
(43) Pub. Date: Feb. 26, 2009

(54) OPTICAL PICKUP DEVICE, OPTICAL INFORMATION DEVICE PROVIDED WITH SUCH OPTICAL PICKUP DEVICE, AND OPTICAL INFORMATION RECORDING/REPRODUCING DEVICE PROVIDED WITH SUCH OPTICAL INFORMATION DEVICE

(76) Inventors: Toshiyasu Tanaka, Osaka (JP); Hironori Okazawa, Osaka (JP); Hideki Hayashi, Nara (JP)

Correspondence Address: WENDEROTH, LIND & PONACK L.L.P., 2033 K. STREET, NW, SUITE 800, WASHINGTON, DC, 20006, US

(21) Appl. No.: 11/912,443

(22) PCT Filed: Apr. 20, 2006
(86) PCT No.: PCT/JP2006/308266

§ 371 Date: Oct. 24, 2007

(30) Foreign Application Priority Data
Apr. 28, 2005 (JP) 2005-131957

(51) Int. Cl. G11B 17/028; G11B 7/00

(52) U.S. Cl. 720/695; 369/100; G9B/7; G9B/17.006

(57) ABSTRACT

A protruding portion 131 is formed on a surface of an optical base 110 on which a light source 101 is placed. A curing-type resin 140 is coated in a gap 132 between a light source holder 111 holding the light source and the protruding portion on the optical base, so that a sufficient securing strength is obtained against an external influence such as a drop impact by using only the curing-type resin, and heat generated from the light source can be efficiently released to the base.

### TECHNICAL FIELD

The present invention relates to an optical pickup apparatus that is capable of at least reading information from an optical disc, an optical information apparatus having the optical pickup apparatus and an optical information recording/reproducing apparatus having the optical information apparatus.

### BACKGROUND ART

There are various kinds of recording media used for recording and storing digital audio data, image data, animation data, as well as document files and data files formed by computers and the like, and optical discs are one kind of these. Among optical discs, the DVD (Digital Versatile Disk) can record a large quantity of information with a higher density in comparison with conventional CDs (Compact Discs), and has come to be widely used in the field of recording apparatuses also, as a medium that is substituted for the VTR (Video Tape Recorder) which is mainly used at present. Moreover, in recent years, examinations on optical discs of the next generation in which the recording density is further increased by using a violet semiconductor laser have been conducted in various places, and the early market introduction is expected. In order to record and reproduce data on and from these optical discs, appropriate optical pickup apparatuses are required.

FIG. 16 shows a structural example of an optical system installed in a conventional optical pickup apparatus 30. The optical pickup apparatus 30 includes a light source 1 having, for example, a semiconductor laser and a photodetector 9 having, for example, a photodiode. A light beam 20 emitted from the light source 1 is beam-shaped by a beam shaping element 2, and converted into parallel light rays by a collimate lens 4 after passing through a beam splitter 3, with the light axis being bent by a raising mirror 5, and condensed onto an information recording face 7a of the optical disc 7 by a condensing lens 6. Light, reflected by the information recording face 7a of the optical disc 7, traces the path reversely so that it is condensed by the collimate lens 4 and reflected by the beam splitter 3, and then condensed onto the photodetector 9. By converting light information to an electric signal by the photodetector 9, the information recorded on the optical disc 7 can be read as an electric signal.

Here, the straight line connecting a light-emitting point position of the light source 1 with an optical center point of the collimate lens 4 is referred to as a light axis 21, and various parts are arranged so that the light axis 21 passes through an optical center point of the condensing lens 6. For this reason, upon assembling the optical pickup apparatus 30, it is essential to adjust the light axis by adjusting the light-emitting point position, that is, the position of the light source 1, and also to provide a structure that makes the light source 1 less vulnerable to positional deviations after the adjustments.

With respect to the method of securing the light source 1 after the light-axis adjustments, generally, as disclosed in Japanese Patent Application Laid-Open No. 2003-132570 and as shown in FIG. 17, a method in which a holder member 31, which is one member of the light source 1 and used for holding the light source 1, is secured to an optical base 30 by a plate spring 32, has been proposed, and as disclosed in Japanese Patent Application Laid-Open No. 2005-32314 as well as in Japanese Utility Model Registration No. 3098794 and as shown in FIG. 18, a method in which a holder member 32 used for holding the light source 1 is secured to the optical base 34 by using a ultraviolet-ray curing resin 35 has also been proposed.

Patent Document 1: Japanese Patent Application Laid-Open No. 2003-132570

Patent Document 2: Japanese Patent Application Laid-Open No.

Patent Document 3: Japanese Utility Model Registration No. 3098794

### DISCLOSURE OF INVENTION

### Subject to be Solved by the Invention

In the method of the prior art, shown in FIG. 17, in which the light-source holder member 31 is secured to the optical base 30 by using the plate spring 32, however, a mechanism used for securing the plate spring 32 to the optical base 30 is required, that is, a large space is required near the light-source holder member 31. The resulting problem is that it is difficult to miniaturize the optical pickup apparatus. Moreover, another problem is that, since the plate spring 32 is required as a securing assist member, there is an increase in the number of members that constitute the optical pickup apparatus.

Moreover, in the method of the prior art, shown in FIG. 18, in which the light-source holder member 33 is secured to the optical base 34 by using the ultraviolet-ray curing resin 35, however, in the case when an external influence, such as a drop impact, is imposed thereon, the light source 1, supported by the light-source holder member 33, tends to cause a positional deviation with respect to the optical base 34, and the holder member 33 tends to come off from the optical base 34. Referring to FIG. 19, the following description will discuss these problems: The optical base 34 and the light-source holder member 33 are secured by placing the ultraviolet-ray curing agent 35 between a back face 33a of the light-source holder member 33 and the optical base 34. Consequently, in the case when, for example, a force is exerted to the light-source holder member 33 in Y-direction (direction penetrating the drawing paper) due to the above-mentioned drop impact or the like, only the portion of a bonding face 35a between the back face 33a of the light-source holder member 33 and the ultraviolet-ray curing resin 35 is subjected to a shearing force, with the result that peeling tends to occur on the bonding face 35a to cause a problem of a weak securing force of the light-source holder member 33.

Moreover, in recent years, there have been developments in a higher output in a red laser light source in order to achieve higher speeds in writing and reading information on and from an optical disc, as well as developments in a shorter wavelength in a laser light in order to achieve reading and writing operations with a large amount of information, that is, the use of a blue laser light. This trend has made the quantity of heat generation in the laser light source greater in comparison with that of the conventional apparatus. Since the heat generation exceeding a permissible level gives adverse effects to the stability of light emission and light irradiation, it becomes very important to release heat from the laser light source in the optical pickup apparatus.

The present invention has been devised to solve the above-mentioned problems, and its objective is to provide an optical pickup apparatus in which a small size and a reduction in the number of parts have been achieved, and which is superior in durability against an external influence such as a drop impact, and has an excellent heat radiating property in the light source, and also to provide an optical information apparatus having the optical pickup apparatus and an optical information recording/reproducing apparatus having the optical information apparatus.

### Means for Solving the Subject

In order to achieve the above-mentioned objective, the present invention has the following arrangements.

An optical pickup apparatus in accordance with a first aspect of the present invention, which is provided with:

a base; and

a light source that is attached to the base and emits light to be applied to an optical information medium,
the optical pickup apparatus at least reading information from the optical information medium,
the base being configured to have a holding section that holds the light source, that a bonding agent used for securing the light source to the base is applied, and that conducts heat generated by the light source to the base,
the holding section being configured to have a wall face that faces a first side face of the light source through a gap and conducts the heat to the base indirectly through the bonding agent to be released, and a mount face that is made in contact with a second side face of the light source and conducts the heat directly to the base to be released, and

with the second side face of the light source being made in contact with the mount face of the holding section so that the light source is held on the holding section, the bonding agent being injected into the gap to be made in contact with the first side face and the wall face and secures the light source to the holding section.

Moreover, an optical pickup apparatus in accordance with a second aspect of the present invention, which is provided with:

a base; and

a light source holder that is attached to the base and holds a light source that emits light to be applied to an optical information medium,
the optical pickup apparatus at least reading information from the optical information medium,
the base being configured to have a holding section that holds the light source holder, that a bonding agent used for securing the light source holder to the base is applied, and that conducts heat generated by the light source and conducted to the light source holder to the base,
the holding section being configured to have a wall face that faces a first side face of the light source holder through a gap and conducts the heat of the light source holder to the base indirectly through the bonding agent to be released, and a mount face that is made in contact with a second side face of the light source holder and conducts the heat of the light source holder directly to the base to be released, and
with the second side face of the light source holder being made in contact with the mount face of the holding section so that the light source holder is held on the holding section, the bonding agent being injected into the gap to be made in contact with the first side face and the wall face and secures the light source holder to the holding section.

In the second aspect, the holding section may have a protruding member that is formed on the base so as to protrude therefrom and has the wall face.

In the second aspect, the protruding member may have a pillar portion that protrudes from the base in a protruding direction and an arm portion that is extended from the pillar portion toward the light source holder side in a direction orthogonal to the protruding direction.

In the second aspect, the light source holder may have a light axis adjusting member and a tilt adjusting member, and in this structure, the arm portion can also be extended to a position near the tilt adjusting member so that the arm portion allows thermal conduction from the tilt adjusting member to the arm portion.

In the second aspect, the holding section may be prepared as a recessed section that is formed on the base and has the wall face and the mount face.

In the second aspect, the holding section may be prepared as a protruding member formed on the base so as to protrude therefrom and a recessed section formed on the base.

In the second aspect, even after the installation position of the light source holder holding the light source has been adjusted, the gap may have a sufficient size that allows the bonding agent to be injected therein.

In the second aspect, the first side face may be constituted by a slope face that expands along a direction in which light, released from the light source, proceeds along the light axis, and the second side face may be constituted by a plane that is extended in a direction orthogonal to, or virtually orthogonal to the proceeding direction of the light.

In the second aspect, the light source holder holding the light source may be provided with an optical element on the light-releasing side of the light source.

In the second aspect, the optical element may be prepared as a beam shaping element that is made of a glass member having a cylindrical face or a non-cylindrical face on each of the light-incident side and the light-releasing side.

In the second aspect, the light source holder may be made of a metal material.

In the second aspect, the bonding agent may be composed of a curing-type resin.

Moreover, an optical information apparatus in accordance with a third aspect of the present invention is provided with:

an optical pickup apparatus relating to the first aspect or the second aspect;

a motor that rotates the optical information medium; and

a control driving circuit that receives a signal obtained from the optical pickup apparatus, and controls and drives the motor and the light source based upon the signal.

Furthermore, an optical information recording/reproducing apparatus in accordance with a fourth aspect of the present invention is provided with:

an optical information apparatus relating to the third aspect;

a processing apparatus that performs operations based upon information obtained from the optical information apparatus; and

an output device that outputs the information obtained from the optical information apparatus and the results of operations performed by the processing apparatus.

The optical information recording/reproducing apparatus of the fourth aspect having the above-mentioned structure can constitute a computer system.

An optical information recording/reproducing apparatus in accordance with a fifth aspect of the present invention is provided with:

an optical information apparatus relating to the third aspect; and

a decoder from information to an image, which converts information obtained from the optical information apparatus to an image.

The optical information recording/reproducing apparatus of the fifth aspect having the above-mentioned structure can constitute an optical information media player.

The optical information recording/reproducing apparatus of the fifth aspect having the above-mentioned structure may be used as a car navigation system.

An optical information recording/reproducing apparatus in accordance with a sixth aspect of the present invention is provided with:

an optical information apparatus relating to the third aspect; and

a decoder from an image to information, which converts image information to information that is recordable onto the optical information medium by the optical information apparatus.

The optical information recording/reproducing apparatus of the sixth aspect having the above-mentioned structure can constitute an optical information media recorder.

Moreover, an optical information recording/reproducing apparatus in accordance with a seventh aspect of the present invention is provided with:

an optical information apparatus relating to the third aspect; and an input/output terminal used for exchange information with an external apparatus.

The optical information recording/reproducing apparatus of the seventh aspect having the above-mentioned structure can constitute an optical disc server.

### Effects of the Present Invention

In accordance with the optical pickup apparatus relating to the first aspect and the second aspect of the present invention, since the base has the holding section, the light source or the light source holder can be secured to the base without using an auxiliary member such as a plate spring, so that the optical pickup apparatus can be miniaturized. Moreover, since a bonding agent, made from, for example, a ultraviolet-ray curing resin, is applied to a gap between the holding section formed on the optical base and the light source as well as the light source holder, it becomes possible to prepare a wider contact area of the bonding agent within a small space between the optical base and the light source as well as the light source holder. In other words, since the securing strength of the light source and the light source holder to the optical base is enhanced, it becomes possible to improve the durability against an external influence, such as a drop impact.

Furthermore, since the holding section has the wall face and the mount face, heat generated from the optical element and the light source holder is effectively conducted to the base so as to be released.

In accordance with the optical information apparatus relating to the third aspect and the optical information recording/reproducing apparatuses relating to the fourth to seventh aspects of the present invention, since the above-mentioned optical pickup apparatus is installed therein, it becomes possible to provide apparatuses that are superior in durability as well as in the radiating property of the light source portion in comparison with conventional apparatuses.

### BRIEF DESCRIPTION OF THE DRAWINGS

FIG. 1 is a schematic perspective view showing a structure of a light-source portion in an optical pickup apparatus in accordance with a first embodiment of the present invention;

FIG. 2A is a schematic cross-sectional view showing the structure of a light-source portion shown in FIG. 1;

FIG. 2B is a schematic cross-sectional view showing a modified example of the light-source portion shown in FIG. 1;

FIG. 2C is a schematic cross-sectional view showing another modified example of the light-source portion shown in FIG. 1;

FIG. 2D is a schematic perspective view showing still another modified example of the light-source portion shown in FIG. 1;

FIG. 2E is a schematic perspective view showing still another modified example of the light-source portion shown in FIG. 1;

FIG. 2F is a schematic perspective view showing still another modified example of the light-source portion shown in FIG. 1;

FIG. 2G is a schematic cross-sectional view showing the structure of the light-source portion shown in FIG. 2E;

FIG. 2H is a schematic perspective view showing still another modified example of the light-source portion shown in FIG. 1;

FIG. 2I is a schematic cross-sectional view showing still another modified example of the light-source portion shown in FIG. 1;

FIG. 2J is a schematic perspective view showing the other modified example of the light-source portion shown in FIG. 1;

FIG. 3A is a schematic perspective view showing a structure of a light-source portion in an optical pickup apparatus in accordance with a second embodiment of the present invention;

FIG. 3B is a schematic cross-sectional view showing the structure of a light-source portion shown in FIG. 3A;

FIG. 3C is a schematic perspective view showing a modified example of the light-source portion shown in FIG. 3A;

FIG. 3D is a schematic cross-sectional view showing the structure of the light-source portion shown in FIG. 3C;

FIG. 4 is a schematic cross-sectional view showing a structure of a light-source portion in an optical pickup apparatus in accordance with a third embodiment of the present invention;

FIG. 5A is a schematic cross-sectional view showing a structure of a light-source portion in an optical pickup apparatus in accordance with a fourth embodiment of the present invention;

FIG. 5B is a schematic cross-sectional view showing a modified example of the light-source portion shown in FIG. 5A;

FIG. 6 is a drawing that shows a schematic structure of an optical information apparatus in accordance with a fifth embodiment of the present invention;

FIG. 7 is a schematic perspective view showing a structure of a computer in accordance with a sixth embodiment of the present invention;

FIG. 8 is a schematic perspective view showing structures of an optical disc player and a car navigation system in accordance with a seventh embodiment of the present invention;

FIG. 9 is a schematic perspective view showing a structure of an optical disc recorder in accordance with an eighth embodiment of the present invention;

FIG. 10 is a schematic perspective view showing a structure of an optical disc server in accordance with a ninth embodiment of the present invention;

FIG. 11 is a perspective view showing a schematic structure of the optical pickup apparatus in each of the first to fourth embodiments;

FIG. 12A is a schematic perspective view that shows a modified example of the light-source portion in the optical pickup apparatus in accordance with each of the first to fourth embodiments;

FIG. 12B is a schematic cross-sectional view showing the light-source portion of FIG. 12A;

FIG. 13 is a schematic perspective view that shows another modified example of the light-source portion in the optical pickup apparatus in accordance with each of the first to fourth embodiments;

FIG. 14 is a schematic perspective view that shows still another modified example of the light-source portion in the optical pickup apparatus in accordance with each of the first to fourth embodiments;

FIG. 15 is a schematic perspective view that shows the other modified example of the light-source portion in the optical pickup apparatus in accordance with each of the first to fourth embodiments;

FIG. 16 is a diagrammatic explanatory drawing that shows a structural example of an optical pickup;

FIG. 17 is a schematic perspective view that shows a structural example of a light-source portion of a conventional optical pickup;

FIG. 18 is a schematic perspective view that shows another structural example of a light-source portion of a conventional optical pickup; and

FIG. 19 is a view that is used for explaining that the securing strength of the light-source portion shown in FIG. 18 is insufficient.

### EXPLANATION OF REFERENCE NUMERALS

7 . . . optical disc 7, 100 . . . optical pickup apparatus, 101 . . . laser light source, 102 . . . optical element, 110 . . . optical base, 111 . . . light-source holder, 112 . . . light source holder, 115 . . . first side face, 115a . . . slope face, 116 . . . side face, 130 . . . holding section, 130a . . . wall face, 130b . . . mount face, 131 . . . rib, 132 . . . gap, 133 . . . recessed section, 140 . . . bonding agent, 150 . . . optical information apparatus, 151 . . . driving device, 153 . . . control driving circuit, 160 . . . computer system, 162 . . . processing apparatus, 163 . . . outputting device, 170 . . . optical disc player, 171 . . . decoder, 176 . . . encoder, 180 . . . information server, 181 . . . input/output terminal, 1121 . . . light source tilt holder, 1122 . . . light axis adjusting holder, 1311 . . . pillar portion, 1312 . . . arm portion.

### BEST MODE FOR CARRYING OUT THE INVENTION

Referring to the drawings, the following description will discuss an optical pickup apparatus, an optical information apparatus and an optical information recording/reproducing apparatus that form embodiments of the present invention. In the drawings, those members that have the same structures are indicated by the same reference numerals.

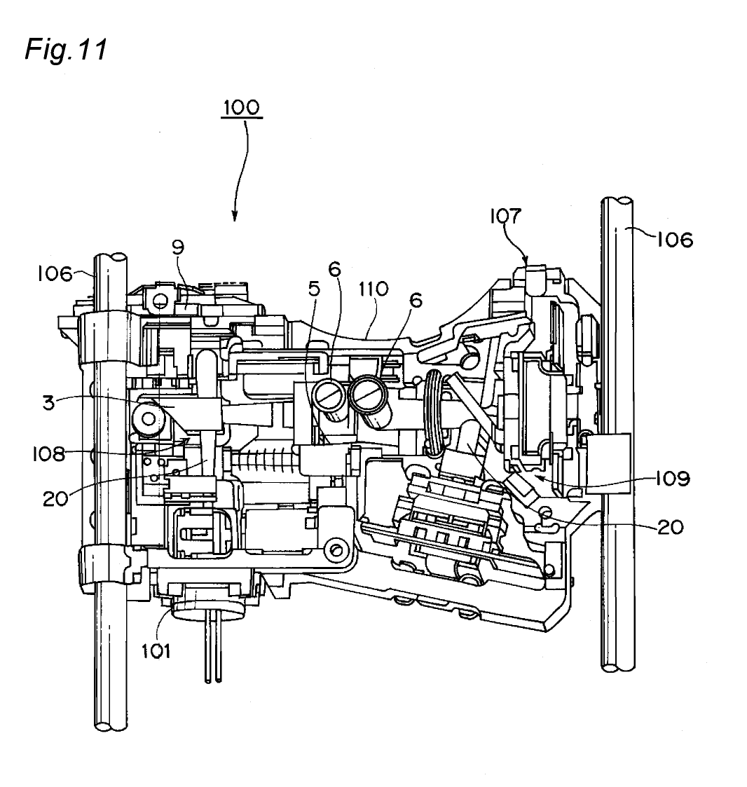

An optical pickup apparatus in accordance with the embodiment is an apparatus which at least reads information from a CD or a DVD, serving as an example of an optical information medium, and, preferably, writes and reads information on and from these. With respect to the information reproducing and recording operations by the optical pickup apparatus, the same operations as those of the aforementioned conventional optical pickup apparatus 30 are carried out, and the explanations thereof are omitted. Here, FIG. 11 shows a so-called carriage 107, which forms a main portion in one example of the above-mentioned optical pickup apparatus. On the carriage 107, an optical pickup for a BD (blu-ray disc) which uses a blue laser beam and has an optical system 108 placed on the left half side of the drawing, and an optical pickup for a CD and a DVD which has an optical system 109 placed on the right half side of the drawing, are mounted on one optical base 110 thereof. Moreover, the carriage 107 is supported by a plurality of guide shafts 106 attached to an optical pickup apparatus 100 in a manner so as to move in radial directions of the CD and the DVD. Although FIG. 11 shows the optical pickup apparatus 100 on which optical pickups for the BD as well as for the CD and the DVD are integrally formed as described above, the optical pickup apparatus is not intended to be limited by this mode, and an optical pickup apparatus exclusively used for each of the DVD, CD and BD may be used, or an optical pickup apparatus in which these three kinds are desirably used in combination may be adopted. In a first embodiment to a fourth embodiment to be discussed below, an optical pickup used for the BD, installed in the above-mentioned optical pickup apparatus 100, will be exemplified, and its light-source portion will be explained. However, the following descriptions relating to each of the first to fourth embodiments are not intended to be limited by the optical pickup used for the BD, and can be applicable to the optical pickup used for the CD and the DVD.

### FIRST EMBODIMENT

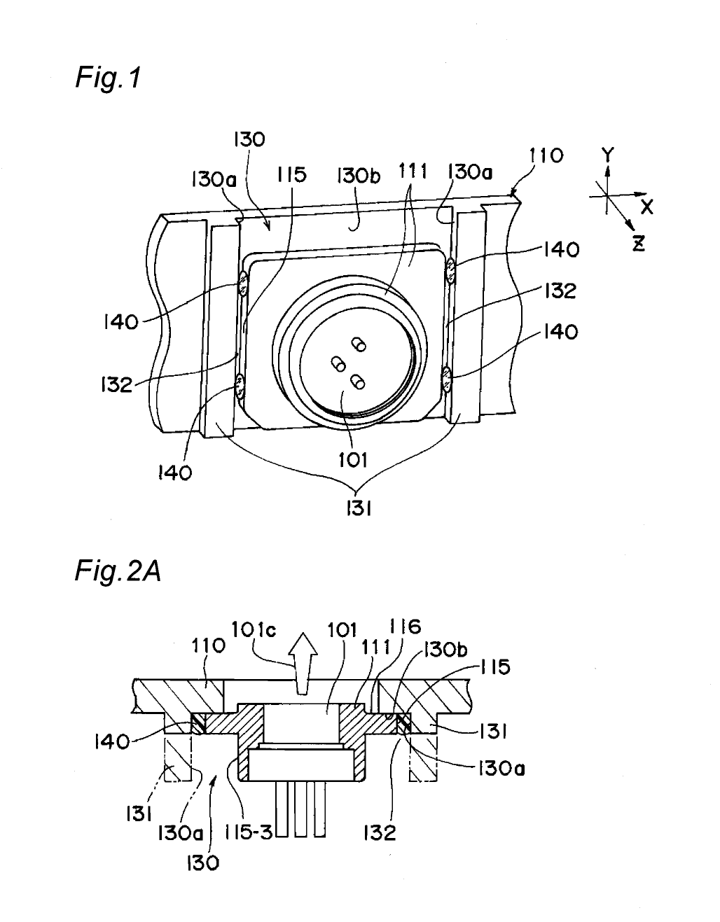

FIG. 1 is a perspective view that shows a structure of a light-source portion within the structure of an optical pickup apparatus in accordance with the first embodiment of the present invention. For convenience of explanation, the other parts of the optical pickup apparatus are not shown in the drawing.

In FIG. 1, reference numeral 101 represents a laser light source that emits a laser light beam 101c having a wavelength λ (390 nm to 415 nm; represented by 405 nm) to an optical information medium, and 111 represents a light source holder that holds the laser light source 101 and is attached to the optical base 110.

The laser light source 101 is preferably prepared as a semiconductor laser light source; thus, it becomes possible to effectively provide an optical pickup and an optical information apparatus having the optical pickup which have a small-size, light-weight and low power consumption.

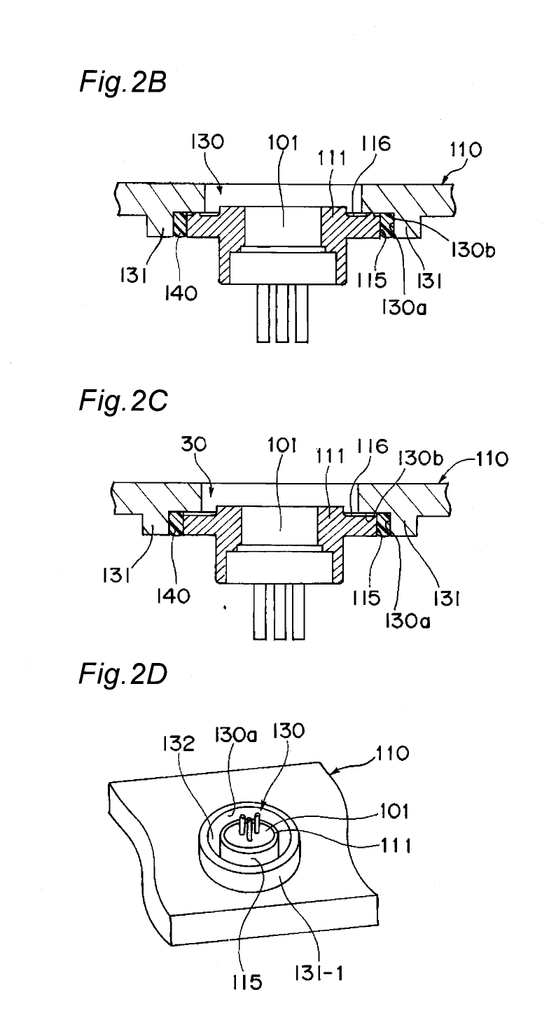

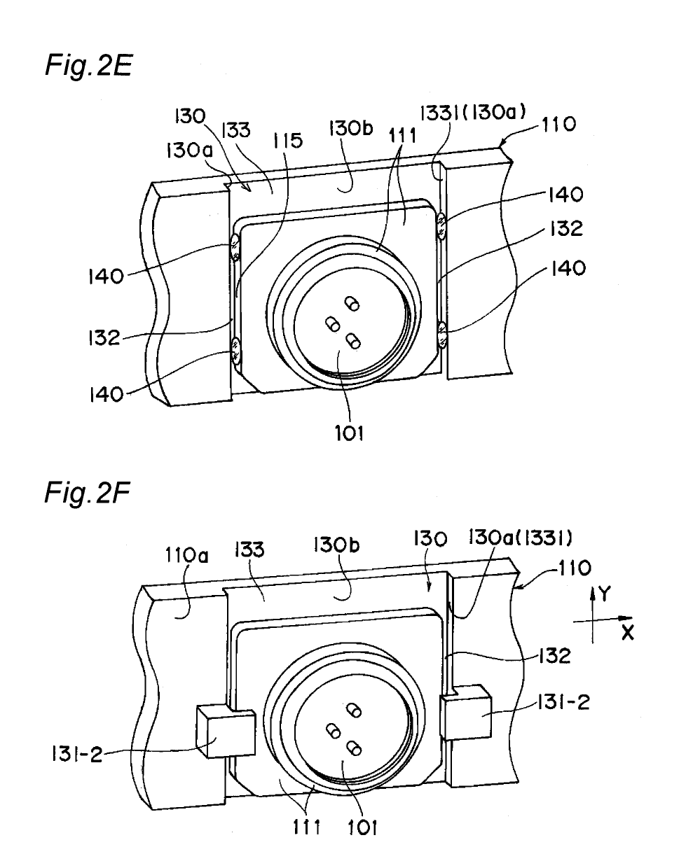

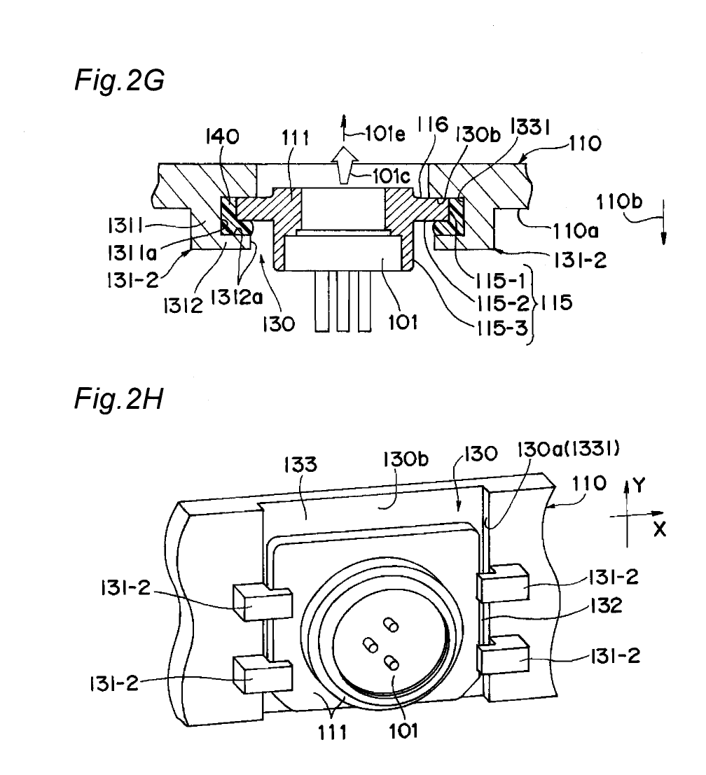

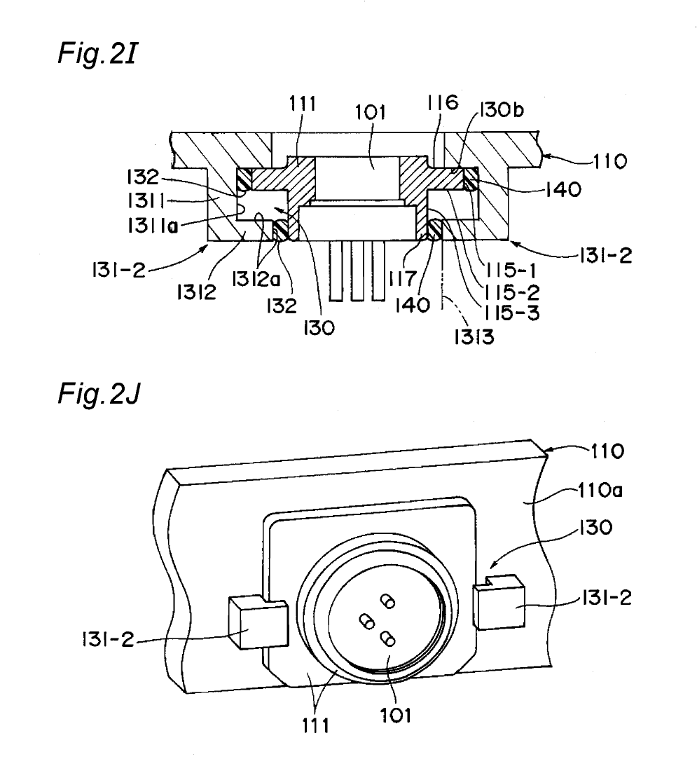

For example, as shown in FIG. 2A, the laser light source 101 is preferably secured to the light source holder 111 that surrounds the light source 101 by using a bonding agent such as an ultraviolet-ray curing resin. This structure makes the outer shape of the laser light source 101 free from an external load, and consequently improves the reliability of the product.

The light source holder 111 is preferably composed of a metal material such as aluminum and zinc so that the holder is made less vulnerable to deformation and damages even if an external influence such as a drop impact is imposed onto the optical pickup. Moreover, by using the metal material, heat generated from the light source 101 that is a heat generation source is effectively conducted to the light source holder 111, making it possible to improve the radiating property of the light source 101.

The optical base 110 to which a bonding agent 140, which is used for securing the light source holder 111 onto the base 110 with the light source holder 111 being held on the base 110, is applied has a holding section 130 that conducts heat, generated in the light source 101 and conducted to the light source holder 111, to the base 110.

The holding section 130 has a wall face 130a and a mount face 130b. The wall face 130a faces a first side face 115 of the light source holder 111 through a gap 132, conducts heat of the light source holder 111 to the base 110 through the bonding agent 140 and release it indirectly. The mount face 130b comes into contact with a second side face 116 of the light source holder 111, conducts the heat of the light source holder 111 to the base 110 and releases it directly.

FIGS. 1 and 2A show an example of one mode of the holding section 130 having the above-mentioned structure. In this mode, the holding section 130 is formed by a storage portion having a structure in which two ribs 131, which correspond to one example of a protruding member formed to the base 110 in a protruding manner, are placed face to face with each other in a manner so as to sandwich the light source holder 111. In this mode, the wall face 130a possessed by the holding section 130 corresponds to a wall face that faces the first side face 115 of the light source holder 111 through the gap 132 in each rib 131. Moreover, the mount face 130b possessed by the holding section 130 corresponds to an outer surface of the base 110 which is made in contact with the second side face 116 of the light source holder 111.

In the holding section 130 having the above-mentioned structure, in a state where the light source holder 111 is held on the holding section 130 with the second side face 116 of the light source holder 111 being made in contact with the mount face 130b of the holding section 130, the bonding agent 140, which is injected to the gap 132, is made in contact with the first side face 115 and the wall face 130a, so that the light source holder 111 is secured onto the holding section 130.

By installing the holding section 130 in this manner, the light source holder 111 with the light source 101 attached thereto is secured to the base 110 by the bonding agent 140 injected to the gap 132, and since the light source holder 111 is placed close to each wall face 130a through the gap 132 so as to be made face to face therewith and also directly made in contact with the mount face 130b, the holding section 130 functions so as to efficiently remove the heat of the light source holder 111.

As will be described below, since the gap 132 forms a space having a minute value, each first side face 115 of the light source holder 111 and each wall face 130a of the holding section 130 are closely placed face to face with each other. Consequently, the radiating effect of the light source holder 111 to the base 110 through the wall face 130a, as described above, can be improved.

Here, the size of the gap 132 is determined based upon the following reasons, and the size of the gap 132 may also be determined from the viewpoint of improving the heat radiating property of the light source holder 111 from the first side face 115 to the wall face 130a.

The light source holder 111, housed in the holding section 130, is made in contact with the optical base 110 through planes of the second side face 116 and the mount face 130b, and allowed to freely slide vertical and lateral directions in FIG. 1 so that the light axis can be adjusted upon assembling this optical pickup. Moreover, the gap 132 has a size that allows the bonding agent 140 to be injected thereto even after the above-mentioned light axis adjustments. For example, the specific value of each gap 132 is set to about 100 μm to 1 mm or less. The value is derived from the above-mentioned light-axis adjustments, and found based upon the fact that the light-emitting point, that is, the laser element, of the light source 101 has a positional error of at least about 80 μm and the production error and the like upon manufacturing the light source portion.

The above-mentioned bonding agent 140 which is made from, for example, a ultraviolet-ray curing resin is injected to the gap 132 so as to be continuously located in contact with at least the two faces of the side face 130a of the rib 131 and the first side face 115 of the light source holder 111. Thus, it becomes possible to prepare a wide contact area without occupying a large space on the optical base 110. With this structure, even in the case when an external influence such as a drop impact is exerted on the optical pickup in X and Y-directions of FIG. 1, the light source holder 111 is free from positional deviations with respect to the optical base 110, so that the resulting effect is that the light axis after the light-axis adjustment is made free from deviations caused by positional deviations of the light source 101. Moreover, even in the case when the external influence is exerted in Z-direction, the light source holder 111 is free from positional deviations with respect to the optical base 110, that is, free from a so-called focal point deviation. Here, the Z-direction is a direction that is coincident or virtually coincident with the light axis direction of the laser light emitted from the light source 101.

In the first embodiment, the bonding agent 140 of the ultraviolet-ray curing resin is supposed to be made in contact with each of the wall faces 130a of the rib 131 and each of the first side faces 115 of the light source holder 111. However, this may be made in contact with the optical base 110 and other parts, or the other face of the rib 131, or the other face of the light source holder 111. Moreover, as shown in FIG. 1, the bonding agent 140 is located in a scattered manner at places corresponding to the four corners of the light source holder 111; however, not limited to this mode, it may be injected to, for example, the entire area of the gap 132, in the case when no limitation is given to the amount of coat.

Moreover, in the first embodiment, the bonding agent 140 of an ultraviolet-ray curing agent (hereinafter, referred to also as “ultraviolet-ray curing resin 140”) is used for a securing purpose; however, this agent may be made from a curing-type resin that is cured by applying an external influence to a flowable resin, such as a thermosetting resin, an anaerobic resin and a moisture-curing resin, and any bonding agent having the same effects may be used. Moreover, from the viewpoint of heat radiation, this agent is preferably made from a material having a high heat conductivity.

Moreover, in the first embodiment, the ribs 131 formed on the optical base 110 are molded integrally with the base 110. However, not limited to this structure, another structure in which another supporting member is secured to the optical base 110 through a method such as welding and bonding may be used with the same effects.

In the first embodiment, the second side face 116 of the light source holder 111 is supposed to be made in contact with the mount face 130b of the optical base 110 through a plane; however, as shown in FIG. 2B and FIG. 2C, it may be made in contact therewith through dots or lines, or may be placed without any contact portion. These contact modes are inferior to the plane-contact mode in heat radiating property; however, since they provide a smaller contact area, the resulting advantage is that the light source holder 111 has a better sliding property upon adjusting the light axis of the light source holder 111.

Moreover, the first side faces 115 forms a side face opposing to the wall face 130a of the holding section 130 as described above; therefore, for example, in the case when, as indicated by a two-dots chain line in FIG. 2A, the protruding member 131 having the wall face 130a is allowed to protrude to the same height as the height of the light source holder 111, the first side face 115 is used as a concept further including a side face of the light-source holder 111 indicated by symbol 115-3.

Moreover, the ribs 131 shown in FIG. 1 are not intended to be limited by a structure that is linearly extended and by a paired structure. For example, as shown in FIG. 2D, a rib 131-1, which has, for example, a cylinder shape that forms a shape corresponding to the outer shape of the first side face 115 of the light source holder 111, and surrounds the first side face 115, may be formed. Moreover, by installing the ribs 131 and 131-1, the rigidity of the base 110 can be enhanced, so that the strength of the base 110 against external influences such as an impact can be improved.

As will be described below, the mode for constructing the holding section 130 is not limited by the method using the rib 131.

In other words, as shown in FIG. 2E, the holding section 130 may be prepared by simply forming a recessed section 133 on the outer surface of the base 110 without forming the ribs 131. In this case, a face corresponding to the bottom face of the recessed section 133 serves as the mount face 130b, and inner faces 1331 of the recessed section 133, which stand on the bottom face, serve as the above-mentioned wall faces 130a.

Moreover, as shown in FIG. 2F and FIG. 2G, by combining the protruding members and the recessed section with each other, a holding section 130 may be formed by using protruding members 131-2 and the recessed section 133. Here, each of the protruding members 131-2 may be extended over the entire length of the light source holder 111, or may be formed in a manner so as to correspond to only one portion of the light source holder 111, as shown in the Figures, without being extended over the entire length of the light source holder 111. In the modes shown in FIG. 2F and FIG. 2G, one of the protruding members 131-2 is formed on each of the two right and left sides of the light source holder 111 so as to correspond to virtually the center portion of the light source holder 111 in Y-direction of X and Y-directions that are orthogonal to the light axis 101e of the laser light beam 101c emitted from the light source 101. Each protruding member 131-2 is constituted by a pillar portion 1311 that protrudes from an outer surface 11a of the base 110 along a protruding direction 110b and an arm portion 1312 that is extended toward the light source holder 111 from the pillar portion 1311 along X-direction that is orthogonal to the protruding direction 110b. The pillar portion 1311 and the arm portion 1312 are integrally formed with the base 110.

In the case when the holding section 130 is formed by the protruding members 131-2 having the above-mentioned bent shape and the recessed section 133, each wall face 130a of the holding section 130 is constituted by the inner face 1331 of the recessed section 133, a wall face 1311a of the pillar portion 1311 and a wall face 1312a of the arm portion 1312. Moreover, the arm portion 1312 is extended in a manner so as to cover one portion of the light source holder 111. Here, the first side face 115 of the light source holder 111 serves as the side face opposing to the wall face 130a of the holding section 130, as described earlier. Therefore, in this mode, each of the side faces of the light source holder 111 that oppose to the wall face 1311a and the wall face 1312a, and are indicated by reference numerals 115-1, 115-2 and 115-3, corresponds to the first side face 115.

Moreover, in the case when the holding section 130 is formed by the protruding members 131-2 and the recessed section 133, as shown in FIG. 2G, the bonding agent 140 is placed in the gap 132 between the wall face 1311a and the wall face 1312a on each of the protruding members 131-2, and the first side face 115 of the light source holder 111 opposing to these wall faces. In addition to this arrangement, as shown in FIG. 1, the bonding agent 140 may be placed in the gap 132 between the inner face 1331 of the recessed section 133 and the first side face 115 of the light source holder 111 opposing to the inner face 1331, for example, so as to cover the four corners of the light source holder 111.

As described above, by forming the holding section 130 in a manner so as to include the protruding members 131-2 having a bent shape, the total area of the wall face 130a of the holding section 130 can be made larger in comparison with the structure provided with the ribs 131. Therefore, the area that can be coated with the bonding agent 140 and the area that is used for heat conduction are made larger, so that the holding section 130 is allowed to hold the light source holder 111 more firmly and the heat releasing efficiency of the light source holder 111 can be further enhanced.

As one modified example of the mode shown in FIG. 2F, a structure in which, as shown in FIG. 2H, two or more protruding members 131-2 are installed may be used. In this case, by arranging the respective protruding members 131-2 at positions that are symmetrical with each other in X and Y-directions, with respect to the light-emitting point of the light source 101, heat radiations from the light source 101 in the respective directions are made equal to one another, so that the temperature change in the light source 101 can be stabilized. Moreover, the bonded portions relating to the respective protruding members 131-2 are placed at positions that are symmetrical in X and Y-directions and allowed to form fixed points; thus, even in the case when the base 110 and the light source holder 111 are expanded or shrunk due to a change in the ambient temperature of the optical pickup apparatus, since the resulting positional deviations in the fixed points relative to the light-emitting point occur symmetrically in X and Y-directions, the resulting effect is that the positional deviation hardly occurs in the light-emitting point.

As another modified example, a structure in which, as shown in FIG. 2I, the arm portion 1312 of each of the protruding members 131-2 is extended up to a proximate position 1313 close to a foot portion 117 on the side reversed to the light-emitting side in the light source holder 111 may be adopted. Here, the proximate position 1313 is preferably prepared as a position that allows heat conduction from the light source holder 111 to the arm portion 1312 of each protruding member 131-2.

By using this structure, the bonding agent 140 can be placed in the gap 132 between the first side face 115-1 of the light source holder 111 and the wall face 1311a of the protruding member 131-2 as well as in the gap 132 between the first side face 115-3 of the light source holder 111 and the wall face 1312a of the protruding member 131-2. Here, the arm portion 1312 supports the foot portion 117 of the light source holder 111 through the bonding agent 140. Therefore, this structure allows the holding section 130 to hold and secure the light source molder 111 more firmly in comparison with the structure shown in FIG. 2G, and also makes the area of the wall face 130a of the holding section 130 larger so that the radiating area can be made larger. Moreover, since heat release is made from a position closer to the heat generating portion, the heat radiating property of the light source holder 111 can be further enhanced.

The above-mentioned embodiment has discussed the structure in which the holding section 130 is formed by the protruding members 131-2 and the recessed section 133; however, as another modified example, a structure in which, as shown in FIG. 2J, only the protruding members 131-2 are used to form the holding section 130 may be adopted.

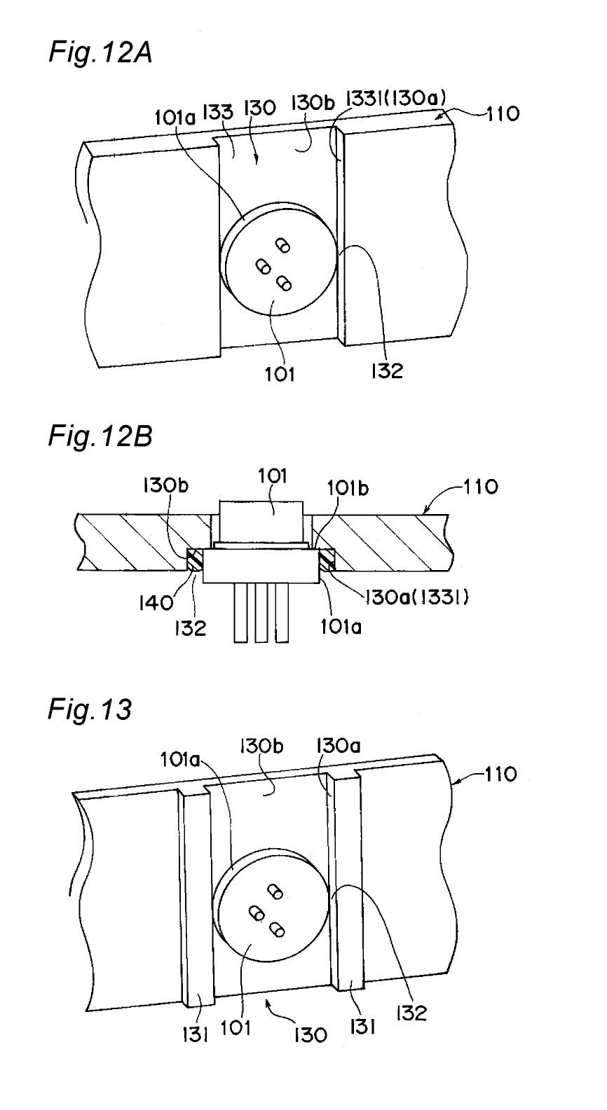

Moreover, in the first embodiment, the light source 101 is supposed to be held on the light source holder 111; however, as shown in FIGS. 12A, 12B, 13 and 14, the light source 101 itself may be secured to the base 110 by the ultraviolet-ray curing resin 140 applied to the gap 132 between the light source 101 and the holding section 130 formed on the optical base 110, and this structure also achieves the same effects.

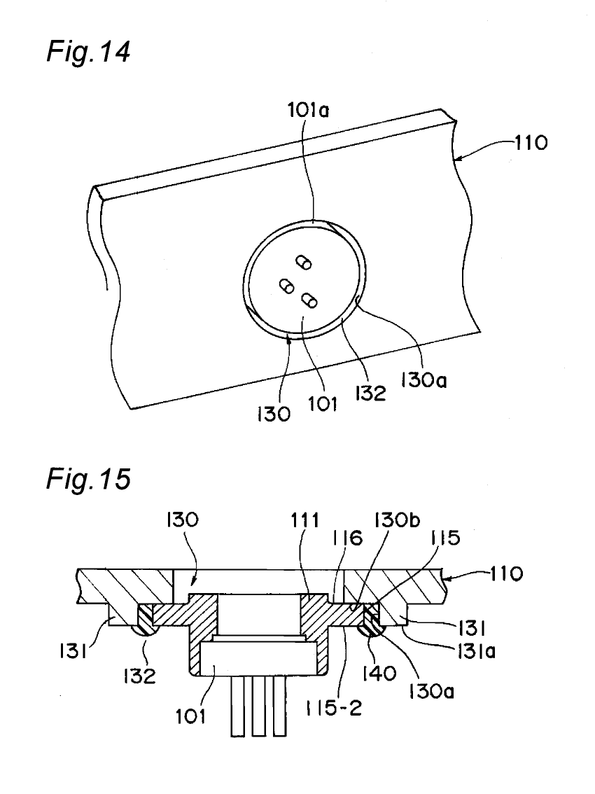

In the holding sections 130 shown in FIGS. 12A, 12B and 14, each holding section 130 is formed by providing a recessed section 133 on the outer surface of the base 110, and in FIG. 13, the holding section 130 is formed by placing ribs 131 on the base 110 in the same manner as the above-mentioned structures. Moreover, the holding section 130 is not intended to be limited by a groove shape that extends linearly as shown in FIG. 12A and FIG. 1, and may have a shape corresponding to the outer shape of the light source 101 or the light source holder 111, that is, such a shape as to surround the outer shape of the light source 101 or the light source holder 111, for example, a round recessed shape as shown in FIG. 14 and a shape formed by a round protruding member 131 as shown in FIG. 2D.

In this case, the light source 101 has a first side face 101a that faces a wall face 130a of a holding section 130 through a gap 132 and corresponds to the first side face 115, and a second side face 101b that is directly made in contact with the mount face 130b of the holding section 130 and corresponds to the second side face 116.

Moreover, in the first embodiment, the light source 101 is prepared as the laser light source that emits a laser light beam having, for example, a wavelength of λ. However, the wavelength may have a value other than this, and a light source other than the semiconductor laser may be used.

Furthermore, in the first embodiment, the light source 101 is supposed to be secured to the light source holder 111 by using an ultraviolet-ray curing resin. However, the light source 101 may be inserted to the light source holder 111, for example, through a press-fit mode or a gap-fit mode, and secured by using another member such as a plate spring, as long as it has the structure such that a large load is not applied to the outer shape of the laser light source 101.

Moreover, in the first embodiment, the light source holder 111 is supposed to be made of a metal material. However, a resin material such as PPS (polystyrene) may be used. The use of the resin material makes it possible to achieve a light-weight apparatus, although the heat conductivity becomes inferior to that of the metal material.

### SECOND EMBODIMENT

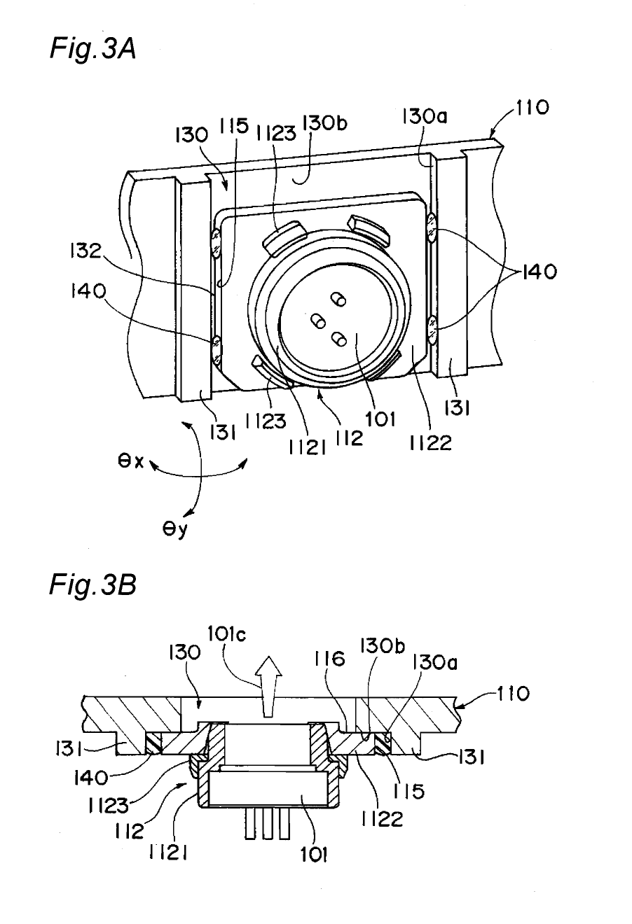

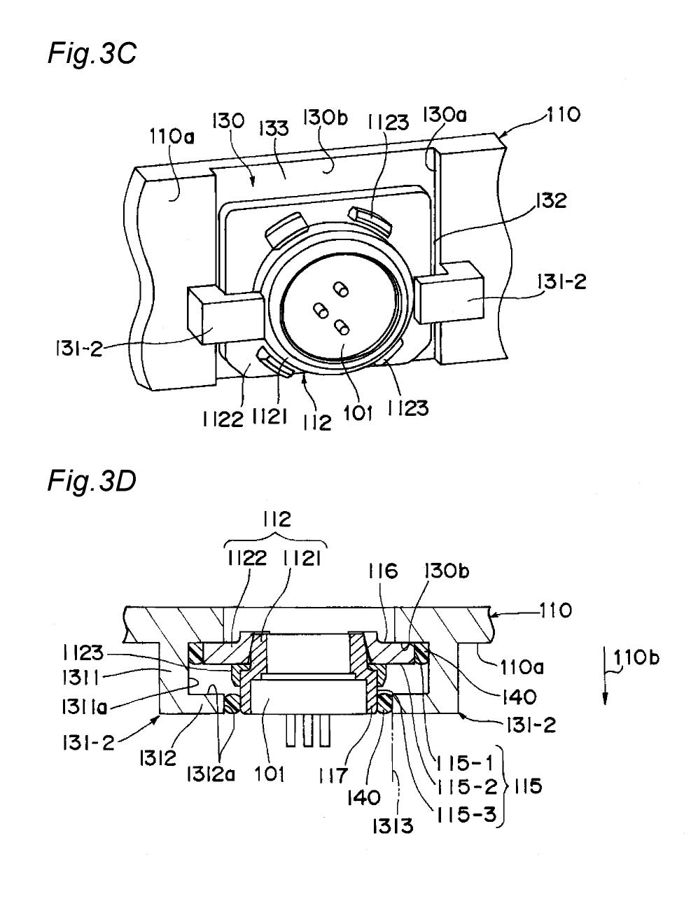

FIGS. 3A to 3D are explanatory drawings that show a structure of a light source portion in the construction of an optical pickup apparatus in accordance with a second embodiment of the present invention. In FIGS. 3A to 3D, those parts having the same structures as those of FIG. 1, FIG. 2A or the like are indicated by the same reference numerals and the descriptions thereof are omitted.

In the aforementioned first embodiment, the light source holder 111, which is formed by a single member, has the structure that is not capable of carrying out a so-called tilt adjustment of the light axis, although it can be shifted in X and Y-directions for adjustments of the installation position. In contrast, in the present second embodiment, the light source holder has a structure that is capable of the tilt adjustment.

In other words, as shown in FIGS. 3A and 3B, a light source holder 112 is constituted by two members, that is, a light source tilt holder 1121 that corresponds to one example of a tilt adjusting member and a light axis adjusting holder 1122 that corresponds to one example of a light axis adjusting member.

The light source 101 is secured to the light source tilt holder 1121 by using the same method as that of the first embodiment, and the light source tilt holder 1121 is made in contact with the light axis adjusting holder 1122 in a manner so as to freely rock thereon. In other words, the light source holder 112 has a structure in which an arc face of the light source tilt holder 1121 is fitted into a cone portion of the light axis adjusting holder 1122. The arc face is made in line-contact with the cone portion, so that the light source tilt holder 1121 is allowed to rock on the light axis adjusting holder 1122.

With this arrangement, in the case when each of the light sources 101 has a tilt in the light-emitting angle upon production, the light source tilt holder 1121 can be tilt-adjusted along θx and θy axes with respect to the light axis adjusting holders 1122, so that the light-emitting angle can be adjusted to a desired angle for each light source tilt holder 1121. After the light-emitting angle adjustment, a second side face 116 of the light axis adjusting holder 1122 is made in plane-contact with the mount face 130b of the optical base 110 in the same manner as the aforementioned light source holder 111. Thus, the light axis adjusting holder 1122 is allowed to freely slide in vertical and lateral directions in FIG. 3A so that this structure makes it possible to carry out light axis adjustments upon assembling an optical pickup. The optical base 110 is provided with the holding section 130 as described earlier. Here, in the structure shown in FIGS. 3A and 3B, the ribs 131 serving as protruding members, each of which has the wall face 130a of the holding section 130, are prepared in the same manner as the structure shown in FIG. 1. Here, a fine gap 132 is formed between each rib 131 formed on the optical base 110 and the light axis adjusting holder 1122. Each gap 132 has a size that allows the bonding agent 140 to be injected thereto even after the above-mentioned light axis adjustments, as described earlier. In each gap 132, the ultraviolet-ray curing resin 140 is applied so as to contact with the wall face 130a of each rib 131 and the first side face 115 of the light axis adjusting holder 1122. Here, the member indicated by reference number 1123 is a support member for the light source tilt holder 1121.

With this arrangement, the light source 101 is subjected to both of deviation adjustments of its light-emitting angle and the light-axis adjustment of the optical pickup upon assembling the optical pickup, and after these adjustments, it achieves the same effects as those shown in the first embodiment. In other words, the light axis adjusting holder 1122 is made free from positional deviations with respect to the base 110 even if an external influence such as a drop impact is imposed onto the optical pickup, and the resulting effect is that after light axis adjustments for positional deviations of the light source 101, the light axis becomes free from deviations.

Moreover, in the present second embodiment also, the structures of the modified examples shown in FIGS. 2B to 2J may be adopted. For example, structures shown in FIGS. 3C and 3D correspond to the structures shown in FIGS. 2F and 2I. In the structures of FIGS. 3C and 3D, the same effects as those obtained in the structure shown in FIG. 2I, that is, the effects that the holding section 130 can firmly hold and secure the light source holder 112 and that the area of the wall face 130a of the holding section 130 is made larger to provide a larger heat radiating area, can be obtained. In particular, since the tilt adjustment for the light axis is required for the light source for the BD, it is necessary to efficiently radiate heat from the light source for the BD which has a quantity of heat generation greater than that of the normally-used light source for the CD and DVD. Here, since the light source tilt holder 1121 requires a rocking movement with respect to the light axis adjusting holder 1122 as described earlier, the light source holder 112 needs to have a structure in which the cone portion of the light axis adjusting holder 1122 and the arc face of the light source tilt holder 1121 are made in contact with each other. Consequently, the light source tilt holder 1121 and the light axis adjusting holder 1122 are simply made in line-contact with each other. Thus, the heat conduction from the light source tilt holder 1121 holding the light source 101 that forms a heat generation source to the light axis adjusting holder 1122 and further to the base 110 is not sufficient.

From these viewpoints, structures, shown in FIGS. 3C and 3D, in which an arm portion 1312 of each protruding member 131-2 is extended further to a proximate position 1313 close to a foot portion 117 on the side reversed to the light-emitting side of the light source tilt holder 1121 with a bonding agent 140 being placed between the light source tilt holder 1121 and each arm portion 1312 can improve the heat conduction from the light source tilt holder 1121 directly made in contact with the light source 101 to each arm portion 1312, and an effective structure which carries out a heat releasing process from the light source 101 efficiently is achieved. Here, the above-mentioned proximate position 1313 is prepared as a position that allows heat conduction from the light source tilt holder 1121 to the arm portion 1312 of each protruding member 131-2.

### THIRD EMBODIMENT

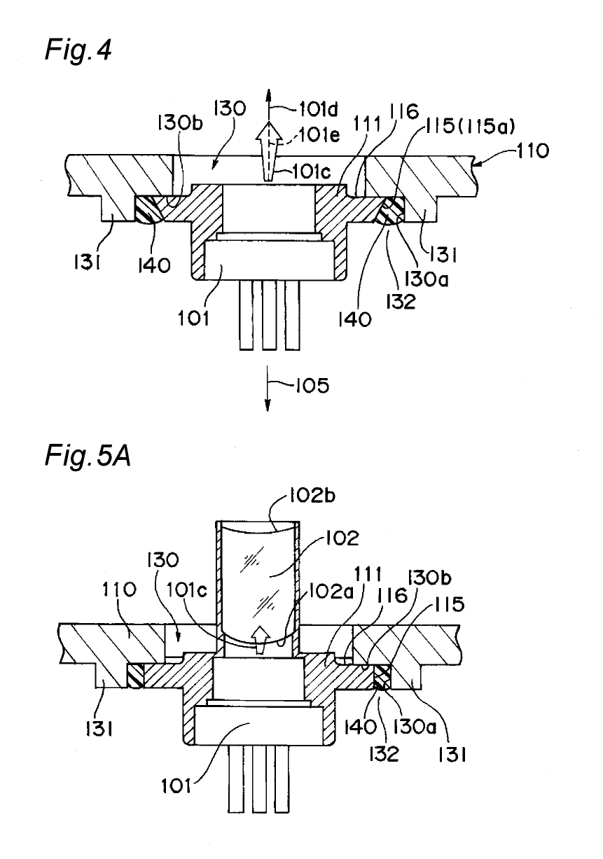

FIG. 4 is a cross-sectional view that shows a structure of a light source portion in the construction of an optical pickup in accordance with a third embodiment of the present invention. In FIG. 4, those parts having the same structures as those of FIG. 1 and the like are indicated by the same reference numerals and the descriptions thereof are omitted.

In the third embodiment, the first side face 115 of the light source holder 111 is formed as a slope that expands from the light source side toward the optical base side, that is, as a wide slope face 115a that expands in a direction 101d in which light proceeds along the light axis 101e of light 101c that is emitted from the light source 101. The light source holder 111 is secured to the optical base 110 by the ultraviolet-ray curing agent 140 that is applied to the gap 132 between the first side face 115 having the slope face of the light source holder 111 and each rib 131 formed on the optical base 110.

In this structure, in the case when an external influence such as a drop impact, for example, a force 105 that is exerted to drop the light source holder 111 from the base 110 is imposed on the optical pickup, if no deformation or damage occurs in the ultraviolet-ray curing resin 140, the light source holder 111 itself has to be deformed or damaged in order that the light source holder 111 comes off from the optical base 110 because of the slope direction of the first side face 115 forming the slope face 115a. Therefore, when the light source holder 111 is formed by using a material having high strength, such as a metal material and a resin material, the securing property of the light source holder 111 to the optical base 110 can be enhanced.

Moreover, in the third embodiment, in the same manner as the second embodiment, the light source holder 111 may be constituted by the light source tilt holder 1121 and the light axis adjusting holder 1122, with a slope being formed on the first side face 115 of the light axis adjusting holder 1122 in the same manner as the third embodiment. With this structure, the same effects as those of the first embodiment and the second embodiment can be obtained in the present third embodiment as well.

Moreover, in the present third embodiment also, the structures of the modified examples shown in FIGS. 2B to 2J may be adopted.

### FOURTH EMBODIMENT

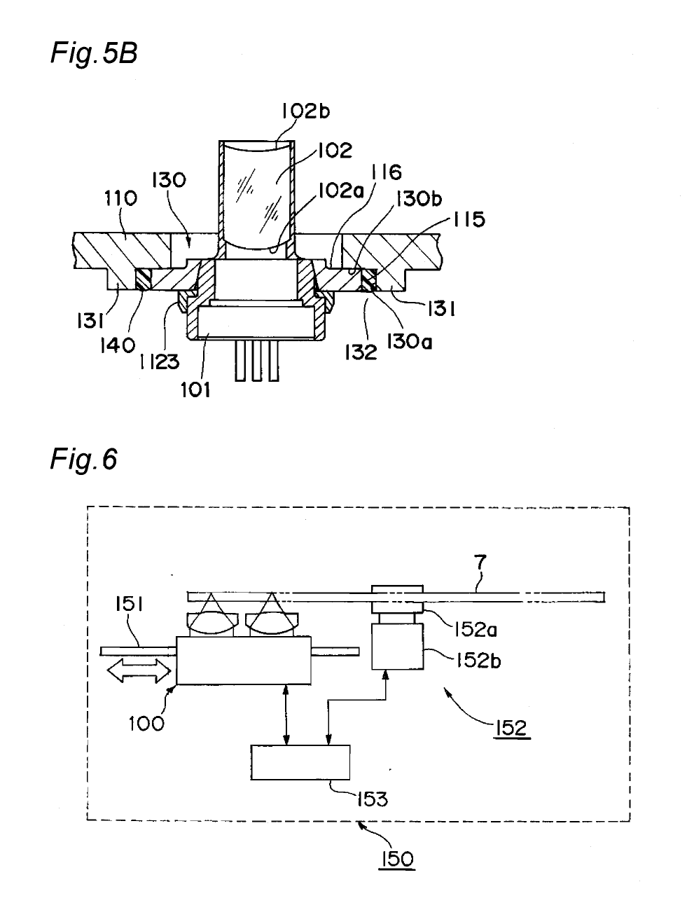

FIGS. 5A and 5B are cross-sectional views that show a structure of a light source portion in the construction of an optical pickup apparatus in accordance with a forth embodiment of the present invention. In FIGS. 5A and 5B, those parts having the same structures as those of FIG. 1 and the like are indicated by the same reference numerals and the descriptions thereof are omitted.

In the present forth embodiment, in addition to a laser light source 101, an optical element 102 is integrally installed on the light source holder 111 on the light-emitting side of the light source 101. In the present forth embodiment, for example, a beam shaping element is used as one example of the optical element 102. Laser light 101c emitted from the light source 101 forms a far field pattern. The beam shaping element, which is an element made of a glass member, shapes the intensity distribution of the laser light 101c emitted from the light source 101 with an elliptical shape into a virtually round shape. In the present forth embodiment, a light-incident side face 102a of the beam shaping element is formed into a non-cylindrical face, while a light-releasing side face 102b is formed into a cylindrical face. Here, with respect to the shapes of the light-incident side face 102a and the light-releasing side face 102b, not limited by the above-mentioned mode, both of the faces may be formed into cylindrical faces or non-cylindrical faces.

With this structure, the beam shaping element 102 can be placed very closely to the laser light source 101. Thus, even in the case when the light source holder 111 is thermally expanded upon a change in the ambient temperature of the optical pickup, the change in the distance between the laser light source 101 and the beam shaping element 102 can be minimized.

In the present forth embodiment as well, the base 110 is provided with the holding section 130, and the light source holder 111 and the optical base 110 are secured by the curing-type resin 140 applied to the gap 132 between each rib 131 formed on the optical base 110 and the light source holder 111, so that the same effects as those of first embodiment can be obtained. In particular, in the case when a member other than the laser light source 101, such as an optical lens, is installed on the light source holder 111 as in the case of the present forth embodiment, even in a structure in which the weight of the entire light source holder is big with an external influence, such as a drop impact, being exerted thereon, that is, a structure in which a relatively large destructive force is imposed on the securing potion of the optical base 110 and the light source holder 111, it becomes possible to make the light source holder 111 less vulnerable to positional deviations with respect to the optical base 110.

The effect that the use of the holding section 130 improves the heat radiating property of the light source 101 as described in the first embodiment can also be obtained by the present forth embodiment.

Moreover, in the present forth embodiment also, the structures of the modified examples shown in FIGS. 2B to 2J, FIGS. 3A to 3D and FIG. 4 may be adopted. FIG. 5B is a drawing that shows a structure in which an optical element 102 is added to the structures shown in FIGS. 3A and 3B.

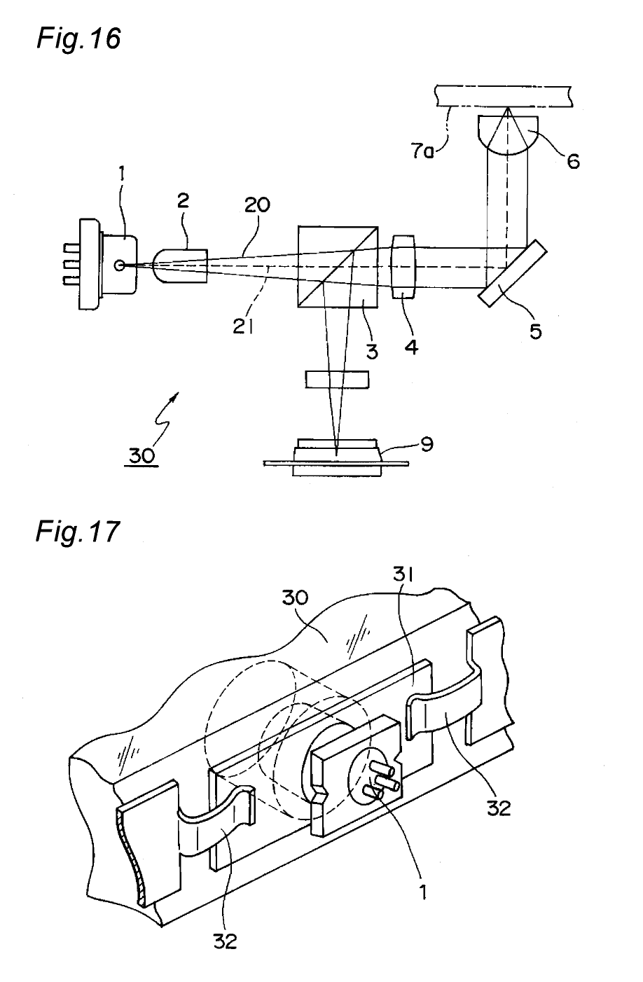

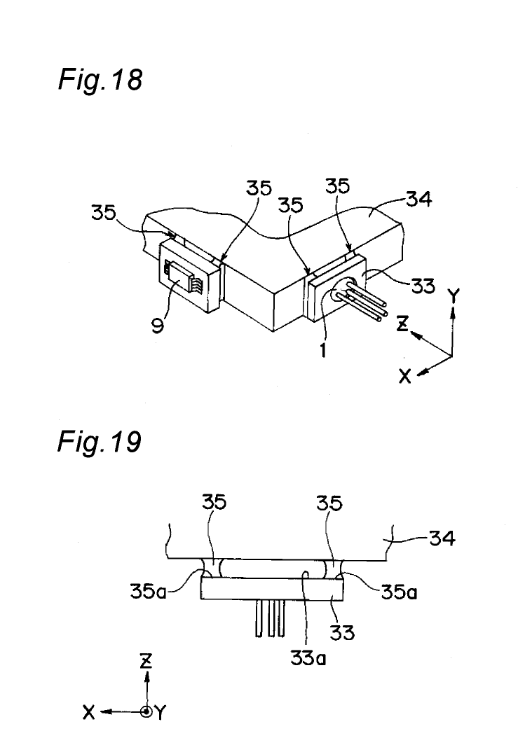

Moreover, in the above-mentioned first to fourth embodiments 1 to 4, the bonding agent 140 is applied in a manner so as not to overflow the gap 132. However, unless a limit is given to the amount of application of the bonding agent 140, the bonding agent 140 may get over each wall face 130a of the holding section 130 and the first side face 115 of the light source holder 111 to overflow the gap 132. For example, in the case of the first embodiment, the bonding agent 140 may be applied so as to be present from the gap 132 up to the first side face 115-2 of the light source holder 111 over the upper face 131a of each rib 131, as shown in FIG. 15.

By applying the bonding agent 140 with such an amount of coat, the light source 101 or the light source holder 111 to which the light source is attached is more firmly secured to the holding section 130, and the heat radiating property from the light source 101 or the light source holder 111 to which the light source is attached to the holding section 130, that is, to the base 110, can be improved.

### FIFTH EMBODIMENT

Next, referring to FIG. 6, the following description will discuss an optical information apparatus relating to another Embodiment of the present invention, which uses the optical pickup apparatus of any one of the above-mentioned first to fourth embodiments.

In FIG. 6, an optical information apparatus 150 has the optical pickup apparatus 100 in accordance with any one of the first to fourth embodiments, a disc rotation system 152 including a turn table 152a on which an optical disc 7 serving as an optical information medium such as a CD and a DVD is placed, and a motor 152b that rotates the optical disc 7, and a control driving circuit 153 which receives a signal obtained from the optical pickup apparatus 100 and controls and drives the motor 152b and the light source 101 based upon the signal. Here, the optical pickup apparatus 100 is also provided with a driving device 151 that allows the carriage 107 to move in radial directions of the optical disc 7.

In the optical information apparatus 150 having the above-mentioned structure, the optical disc 7, mounted on the turn table 152a, is rotated by the motor 152b. The optical pickup apparatus 100 is roughly shifted to a track, on which desired information is located, of the optical disc 7 by the driving device 151 of the optical pickup.

The optical pickup apparatus 100 also sends a focus error signal and a tracking error signal to the control driving circuit 153 in response to the positional relationship with the optical disc 7. The control driving circuit 153 sends a signal used for finely moving an objective lens mounted on the carriage 107 of the optical pickup apparatus 100 to the optical pickup apparatus 100 in accordance with these focus error signal and tracking error signal. Based upon the objective lens shifting signals, a focus control operation and a tracking control operation to the optical disc 7 are carried out in the optical pickup apparatus 100. Thus, the optical pickup apparatus 100 reads information from the optical disc 7, and also writes (records) and erases information to and from the optical disc 7.

Here, the optical information apparatus 150 is provided with the optical pickup apparatus 100 in which the optical pickup used for BDs and the optical pickup used for CDs and DVDs are integrally formed. However, the optical information apparatus 150 may be provided with optical pickups exclusively used for DVDs, CDs and BDs respectively, or may be an optical information apparatus 150 provided with an optical pickup apparatus in which these three kinds are desirably used in combination.

The following description will discuss various modes of an optical information recording/reproducing apparatus in which the optical information apparatus 150 explained in the above-mentioned fifth embodiment is installed. Computers, optical disc players and optical disc recorders, which are provided with the optical information apparatus 150 of the above-mentioned fifth embodiment, or adopt the above-mentioned recording/reproducing method, can stably record or reproduce information on or from different kinds of optical discs, and can be effectively used in wider applications. Here, the optical information recording/reproducing apparatus is not necessarily required to perform information recording and reproducing operations, and any apparatus may be used as long as it can at least reproduce information.

### SIXTH EMBODIMENT

As one example of the optical information recording/reproducing apparatus, the following description will discuss an Embodiment of a computer system which is provided with the optical information apparatus 150 described in the fifth embodiment.

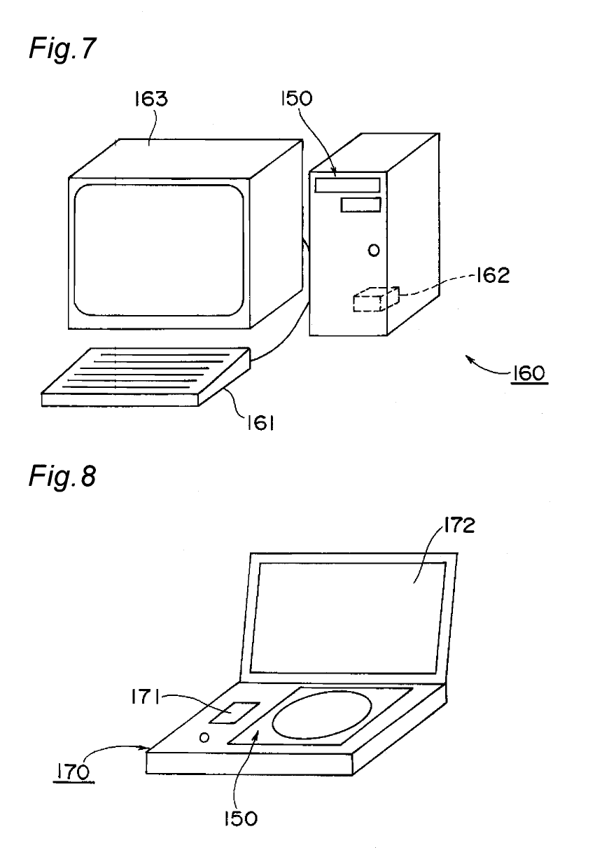

In FIG. 7, a computer system 160 has the optical information apparatus 150 of the fifth embodiment, an input device 161 including a keyboard, a mouse, a touch panel, or the like used for inputting information, a processing apparatus 162 such as a central processing unit (CPU), which performs operations based upon information inputted by the input device 161 and information or the like read from the optical information apparatus 150, a CRT or a liquid crystal display that displays information such as the result of operations carried out by the processing apparatus 162, and an outputting device 163 such as a printer. Here, in the computer system 160, the input device 161 is not an essential constituent part.

### SEVENTH EMBODIMENT

As one example of the optical information recording/reproducing apparatus, referring to FIG. 8, the following description will discuss an Embodiment of an optical disc player which is provided with the optical information apparatus 150 described in the fifth embodiment.

In FIG. 8, an optical disc player 170 has the optical information apparatus 150 of the fifth embodiment and a conversion device from information to an image, for example, a decoder 171, which converts an information signal from an optical disc 7, obtained from the optical information apparatus 150, to an image. Here, the present structure may be utilized as a car navigation system. Moreover, another mode in which a display device 172 such as a liquid crystal monitor is added to the present structure may be utilized.

### EIGHTH EMBODIMENT

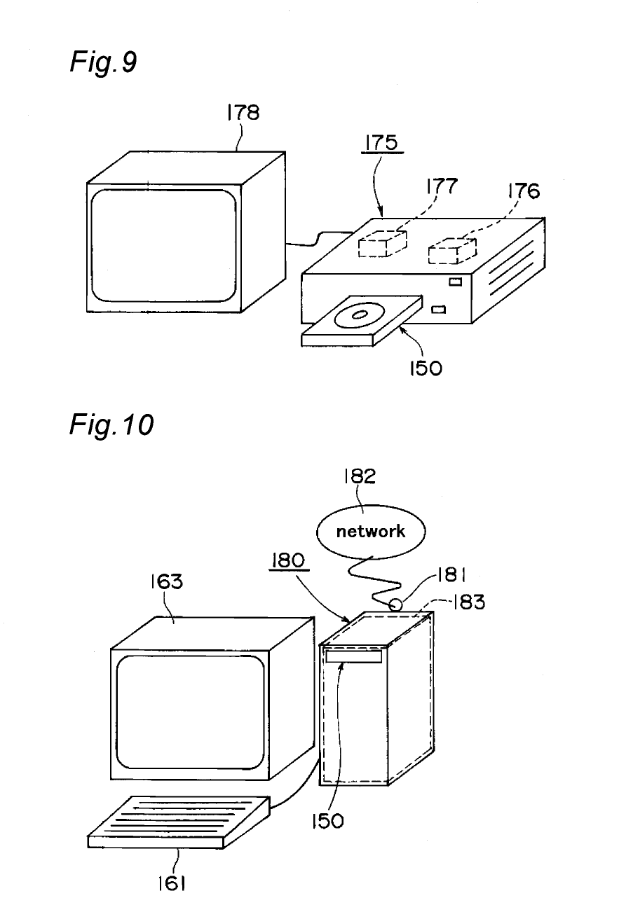

As another example of the optical information recording/reproducing apparatus, referring to FIG. 9, the following description will discuss an Embodiment of an optical disc recorder which is provided with the optical information apparatus 150 described in the fifth embodiment.

In FIG. 9, an optical disc recorder 175 has the optical information apparatus 150 of the fifth embodiment and a conversion device from an image to information, for example, an encoder 176, which converts image information to information to be recorded on an optical disc 7 by the optical information apparatus 150. Preferably, it is also provided with a conversion device from information to an image, for example, a decoder 177, which converts an information signal from an optical disc 7, obtained from the optical information apparatus 150, to an image. Thus, a portion already recorded on the optical disc 7 can be reproduced. Moreover, it may also be provided with a CRT or a liquid crystal display that displays information to be recorded or reproduced information, and an outputting device 178 such as a printer.

### NINTH EMBODIMENT

As still another example of the optical information recording/reproducing apparatus, referring to FIG. 10, the following description will discuss an Embodiment of an information server which is provided with the optical information apparatus 150 described in the fifth embodiment.

In FIG. 10, an information server 180 has the optical information apparatus 150 of the fifth embodiment and an input/output terminal 181. The input/output terminal 181 is an input/output terminal for cable or radio, connected to a network 182, which receives information to be recorded on an optical disc 7 through the optical information apparatus 150, or outputs information read from the optical disc 7 by the optical information apparatus 150 to the network 182. With this arrangement, the information server 180 sends and receives information through the network 182, that is, to and from a plurality of apparatuses, such as computers, telephones and TV tuners, and is utilized by these apparatuses as a common information server, that is, as an optical disc server. In the case when the optical information apparatus 150 is equipped with the optical pickup for BDs, as well as the optical pickup for CDs and DVDs, the resulting information server 180 is allowed to stably record or reproduce information on or from different kinds of optical discs 7, and can be effectively used in wider applications. A CRT and a liquid crystal display used for displaying information, and an outputting device 163 such as a printer may be installed therein. Moreover, an input device 161 including a keyboard, a mouse, a touch panel or the like used for inputting information may be installed therein.

Furthermore, a changer 183, which loads and unloads a plurality of optical discs 7 to and from the optical information apparatus 150, may be installed therein so that many pieces of information can be recorded and accumulated therein.

In the above-mentioned sixth to ninth embodiment, the outputting devices 163 and 178, and the liquid crystal monitor 172 are shown in FIGS. 7 to 10. However, another commodity mode may of course be proposed in which: only an output terminal is prepared without the output devices 163 and 178 and the liquid crystal monitor 172, and these devices are ordered separately. Moreover, although no input device is shown in FIGS. 8 and 9, another commodity mode in which an input device, such as a keyboard, a touch panel, a mouse and a remote control device, is prepared may be proposed. In contrast, in the above-mentioned sixth to ninth embodiments, the other mode, which provides only the input terminal, with an input device being ordered separately, may be proposed.

Here, by properly combining the above-mentioned first to ninth embodiments, an optical pickup apparatus, an optical information apparatus and an optical information recording/reproducing apparatus may be configured.

All the contents including the specification, claims, Figures and Abstract disclosed in Japanese Patent Application No. 2005-131957, filed on Apr. 28, 2005, are incorporated by reference herein.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

### INDUSTRIAL APPLICABILITY

The present invention relates to an optical information recording/reproducing apparatus that records or reproduces information on or from an optical information recording medium by applying light thereto through an optical pickup, and is applicable to wide industrial fields from computers to AV apparatuses that utilize optical discs. Thus, its industrial applicability is very wide and large.

1. An optical pickup apparatus, comprising:
a base; and
a light source that is attached to the base and emits light to be applied to an optical information medium,
the optical pickup apparatus at least reading information from the optical information medium,
the base being configured to have a holding section that holds the light source, that a bonding agent used for securing the light source to the base is applied, and that conducts heat generated by the light source to the base,
the holding section being configured to have a wall face that faces a first side face of the light source through a gap and conducts the heat to the base indirectly through the bonding agent to be released, and a mount face that is made in contact with a second side face of the light source and conducts the heat directly to the base to be released, and
with the second side face of the light source being made in contact with the mount face of the holding section so that the light source is held on the holding section, the bonding agent being injected into the gap to be made in contact with the first side face and the wall face and secures the light source to the holding section.

2. An optical pickup apparatus, comprising:
a base; and
a light source holder that is attached to the base and holds a light source that emits light to be applied to an optical information medium,
the optical pickup apparatus at least reading information from the optical information medium,
the base being configured to have a holding section that holds the light source holder, that a bonding agent used for securing the light source holder to the base is applied, and that conducts heat generated by the light source and conducted to the light source holder to the base,
the holding section being configured to have a wall face that faces a first side face of the light source holder through a gap and conducts the heat of the light source holder to the base indirectly through the bonding agent to be released, and a mount face that is made in contact with a second side face of the light source holder and conducts the heat of the light source holder directly to the base to be released, and
with the second side face of the light source holder being made in contact with the mount face of the holding section so that the light source holder is held on the holding section, the bonding agent being injected into the gap to be made in contact with the first side face and the wall face and secures the light source holder to the holding section.

3. The optical pickup apparatus according to claim 2, wherein the holding section has a protruding member that is formed on the base so as to protrude therefrom and has the wall face.

4. The optical pickup apparatus according to claim 3, wherein the protruding member has a pillar portion that protrudes from the base in a protruding direction and an arm portion that is extended from the pillar portion toward the light source holder side in a direction orthogonal to the protruding direction.

5. The optical pickup apparatus according to claim 4, wherein the light source holder includes a light axis adjusting member and a tilt adjusting member, and the arm portion is extended to a position near the tilt adjusting member so that the arm portion allows thermal conduction from the tilt adjusting member to the arm portion.

6. The optical pickup apparatus according to claim 2, wherein the holding section is formed by a recessed section that is formed on the base and has the wall face and the mount face.

7. The optical pickup apparatus according to claim 2, wherein the holding section is formed by a protruding member formed on the base so as to protrude therefrom and a recessed section formed on the base.

8. The optical pickup apparatus according to claim 2, wherein, even after the installation position of the light source holder holding the light source has been adjusted, the gap has a sufficient size that allows the bonding agent to be injected therein.

9. The optical pickup apparatus according to claim 2, wherein the first side face is formed by a slope face that expands along a direction, in which light released from the light source proceeds along the light axis, and the second side face is a plane that is extended in a direction orthogonal to, or virtually orthogonal to the proceeding direction of the light.

10. The optical pickup apparatus according to claim 2, wherein the light source holder holding the light source has an optical element on the light-releasing side of the light source.

11. The optical pickup apparatus according to claim 10, wherein the optical element is a beam shaping element that is made of a glass member having a cylindrical face or a non-cylindrical face on each of the light-incident side and the light-releasing side.

12. The optical pickup apparatus according to claim 2, wherein the light source holder is made of a metal material.

13. The optical pickup apparatus according to claim 2, wherein the bonding agent is composed of a curing-type resin.

14. An optical information apparatus comprising:
an optical pickup apparatus that includes a base, and a light source holder that is attached to the base and holds a light source that emits light to be applied to an optical information medium,
the optical pickup apparatus at least reading information from the optical information medium,
the base being configured to have a holding section that holds the light source holder, that a bonding agent used for securing the light source holder to the base is applied, and that conducts heat generated by the light source and conducted to the light source holder to the base,
the holding section being configured to have a wall face that faces a first side face of the light source holder through a gap and conducts the heat of the light source holder to the base indirectly through the bonding agent to be released, and a mount face that is made in contact with a second side face of the light source holder and conducts the heat of the light source holder directly to the base to be released, and
with the second side face of the light source holder being made in contact with the mount face of the holding section so that the light source holder is held on the holding section, the bonding agent being injected into the gap to be made in contact with the first side face and the wall face and secures the light source holder to the holding section;
a motor that rotates the optical information medium; and
a control driving circuit that receives a signal obtained from the optical pickup apparatus, and controls and drives the motor and the light source based upon the signal

15. An optical information recording/reproducing apparatus comprising:
an optical information apparatus that includes an optical pickup apparatus, a motor, and a control driving circuit,
the optical pickup apparatus including a base, and a light source holder that is attached to the base and holds a light source that emits light to be applied to an optical information medium,
the optical pickup apparatus at least reading information from the optical information medium,
the base being configured to have a holding section that holds the light source holder, that a bonding agent used for securing the light source holder to the base is applied, and that conducts heat generated by the light source and conducted to the light source holder to the base,
the holding section being configured to have a wall face that faces a first side face of the light source holder through a gap and conducts the heat of the light source holder to the base indirectly through the bonding agent to be released, and a mount face that is made in contact with a second side face of the light source holder and conducts the heat of the light source holder directly to the base to be released, and with the second side face of the light source holder being made in contact with the mount face of the holding section so that the light source holder is held on the holding section, the bonding agent being injected into the gap to be made in contact with the first side face and the wall face and secures the light source holder to the holding section,
the motor rotating the optical information medium; and
the control driving circuit receiving a signal obtained from the optical pickup apparatus, and controlling and driving the motor and the light source based upon the signal;
a processing apparatus that performs operations based upon information obtained from the optical information apparatus; and
an output device (163) that outputs the information obtained from the optical information apparatus and the results of operations performed by the processing apparatus.

16. An optical information recording/reproducing apparatus comprising:
an optical information apparatus that includes an optical pickup apparatus, a motor, and a control driving circuit,
the optical pickup apparatus including a base, and a light source holder that is attached to the base and holds a light source that emits light to be applied to an optical information medium,
the optical pickup apparatus at least reading information from the optical information medium,
the base being configured to have a holding section (130) that holds the light source holder, that a bonding agent used for securing the light source holder to the base is applied, and that conducts heat generated by the light source and conducted to the light source holder to the base,
the holding section being configured to have a wall face (130a) that faces a first side face of the light source holder through a gap and conducts the heat of the light source holder to the base indirectly through the bonding agent to be released, and a mount face that is made in contact with a second side face of the light source holder and conducts the heat of the light source holder directly to the base to be released, and
with the second side face of the light source holder being made in contact with the mount face of the holding section so that the light source holder is held on the holding section, the bonding agent being injected into the gap to be made in contact with the first side face and the wall face and secures the light source holder to the holding section,
the motor rotating the optical information medium; and
the control driving circuit receiving a signal obtained from the optical pickup apparatus, and controlling and driving the motor and the light source based upon the signal; and
a decoder from information to an image, configured to convert information obtained from the optical information apparatus to an image.

17. The optical information recording/reproducing apparatus according to claim 16, which is used as a car navigation system.

18. An optical information recording/reproducing apparatus comprising:
an optical information apparatus that includes an optical pickup apparatus, a motor, and a control driving circuit,
the optical pickup apparatus including a base, and a light source holder that is attached to the base and holds a light source that emits light to be applied to an optical information medium,
the optical pickup apparatus at least reading information from the optical information medium,
the base being configured to have a holding section (130) that holds the light source holder, that a bonding agent used for securing the light source holder to the base is applied, and that conducts heat generated by the light source and conducted to the light source holder to the base,
the holding section being configured to have a wall face (130a) that faces a first side face of the light source holder through a gap and conducts the heat of the light source holder to the base indirectly through the bonding agent to be released, and a mount face that is made in contact with a second side face of the light source holder and conducts the heat of the light source holder directly to the base to be released, and
with the second side face of the light source holder being made in contact with the mount face of the holding section so that the light source holder is held on the holding section, the bonding agent being injected into the gap to be made in contact with the first side face and the wall face and secures the light source holder to the holding section,
the motor rotating the optical information medium; and
the control driving circuit receiving a signal obtained from the optical pickup apparatus, and controlling and driving the motor and the light source based upon the signal; and
an encoder (176) from an image to information, configured to convert image information to information that is recordable onto the optical information medium by the optical information apparatus.

19. An optical information recording/reproducing apparatus comprising:
an optical information apparatus that includes an optical pickup apparatus, a motor, and a control driving circuit,
the optical pickup apparatus including a base, and a light source holder, that is attached to the base and holds a light source that emits light to be applied to an optical information medium,
the optical pickup apparatus at least reading information from the optical information medium,
the base being configured to have a holding section that holds the light source holder, that a bonding agent used for securing the light source holder to the base is applied, and that conducts heat generated by the light source and conducted to the light source holder to the base,
the holding section being configured to have a wall face that faces a first side face of the light source holder through a gap and conducts the heat of the light source holder to the base indirectly through the bonding agent to be released, and a mount face that is made in contact with a second side face of the light source holder and conducts the heat of the light source holder directly to the base to be released, and
with the second side face of the light source holder being made in contact with the mount face of the holding section so that the light source holder is held on the holding section, the bonding agent being injected into the gap to be made in contact with the first side face and the wall face and secures the light source holder to the holding section,
the motor rotating the optical information medium; and
the control driving circuit receiving a signal obtained from the optical pickup apparatus, and controlling and driving the motor and the light source based upon the signal; and
an input/output terminal configured to exchange information with an external apparatus.

20. An optical pickup apparatus, comprising:
a base; and
a light source holder that is attached to the base and holds a light source that emits light to be applied to an optical information medium, the optical pickup apparatus at least reading information from the optical information medium,
the base being configured to have a holding section that holds the light source holder, that a bonding agent used for securing the light source holder to the base is applied, and that conducts heat generated by the light source and conducted to the light source holder to the base,
the light source holder being configured to include a light axis adjusting member and a tilt adjusting member,
the holding section being configured to have a wall face that faces a first side face of the light axis adjusting member in the light source holder through a gap and conducts the heat of the light source holder to the base indirectly through the bonding agent to be released, and a mount face that is made in contact with a second side face of the light axis adjusting member in the light source holder and conducts the heat of the light source holder directly to the base to be released, and
with the second side face of the light axis adjusting member being made in contact with the mount face of the holding section so that the light source holder is held on the holding section, the bonding agent being injected into the gap to be made in contact with the first side face and the wall face and secures the light source holder to the holding section.

21. The optical pickup apparatus according to claim 2, wherein the gap is set to 100 μm or more.
